(19) United States
(12) Patent Application Publication
(10) Pub. No.: US 2018/0042090 A1
(43) Pub. Date: Feb. 8, 2018

(54) Systems, Apparatuses, and Methods for Lighting Management

(71) Applicant: Echelon Corporation, Santa Clara, CA (US)

(72) Inventors: Glen M. Riley, Saratoga, CA (US); John G. Waclawsky, Alpine, WY (US)

(21) Appl. No.: 15/226,783

(22) Filed: Aug. 2, 2016

(51) Int. Cl. H05B 37/02; H04L 12/24; H05B 33/08

(52) U.S. Cl. CPC H05B 37/0272; H05B 33/0845; H05B 33/0857; H05B 37/0227; H04L 41/12; H05B 37/0263; H04L 41/0813

(57) ABSTRACT

Systems, methods, and apparatuses are described that manage lighting configurations. In some embodiments, an apparatus includes a processor to execute instructions stored in memory, a communication interface coupled to the processor to communicate with an external device; and memory to store instructions which when executed by the processor to provide provisioning capabilities for the apparatus, wherein the memory to further store a node information structure including identifiers for each node coupled to the apparatus and configurations available to those nodes.

### FIELD OF INVENTION

The field of invention relates generally to lighting, and, more specifically, to lighting configuration management.

### BACKGROUND

Modern commercial indoor and outdoor lighting systems are being asked to do more than ever before. In addition to fulfilling their primary purpose of supplying light for homes and business as well as casting light onto dark roadways, parking areas, and public spaces, lighting systems are increasingly evaluated for how well they reduce energy consumption, improve safety for both pedestrians and drivers, and serve as the foundation for a range of applications including the emergence of human centric lighting applications.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of an exemplary system.

FIG. 2 illustrates an exemplary embodiment of a gateway.

FIG. 3 illustrates an exemplary embodiment of a node.

FIG. 4 illustrates an embodiment of lighting configurations added to a gateway.

FIG. 5 illustrates an exemplary PNI based layout for choosing a NIM value.

FIG. 6 illustrates an embodiment of a method for a node to get a lighting configuration from a gateway or a server.

FIG. 7 illustrates an embodiment of a method to change a lighting configuration at a gateway or node.

FIG. 8 illustrates an embodiment of a lighting device that uses command loops to drive one or more LEDs.

FIG. 9 illustrates an exemplary embodiment of a command.

FIG. 10 illustrates an embodiment of a method performed by a lighting device using a command loop.

FIG. 11 illustrates an embodiment of a method performed by a lighting device using a command loop.

FIG. 12 illustrates an example of a loop and a tuned loop.

FIG. 13 illustrates an embodiment of a method performed by a lighting device using a command loop.

FIG. 14 illustrates an embodiment of a method performed by a lighting device using a command loop.

FIG. 15 illustrates an embodiment of a method of updating a command loop.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Detailed below are embodiments of systems, apparatuses, and methods to manage lighting configurations. Lighting configurations provide the ability to finely control LED light output, such as brightness and/or change light frequencies and/or the mix of light frequencies, etc. to minimize potential harmful human health and environmental effects. For example, white LED light has a large component of blue light and is estimated to be five times more effective at suppressing melatonin at night than the high pressure sodium lamps (given the same light output) which have been the mainstay of street lighting for decades. Melatonin suppression due to too much blue light is a marker of circadian disruption, which includes disrupted sleep.

In particular, the embodiments detailed below allow for simpler installation and the fine controlling of lighting devices on a network using tuning configurations. Throughout this description, configurations are a set of instructions or a script of commands. etc. that configure LED light output by setting brightness levels, changing output light frequencies, flashing or dimming lights of particular frequencies, modifying the light color or frequency mix of light mix. For example, outdoor lighting at night should have a color temperature of no greater than 3000 Kelvin (K). Color temperature (CT) is a measure of the spectral content of light from a source; how much blue, green, yellow and red there is in light. A higher CT rating generally means greater blue content, and the whiter the light appears. Too much blue and the light can appear harsh and cause discomfort and make some tasks (e.g., driving) more difficult. Tuning configurations can adjust the spectral content of the light. Tuning configurations are loaded into LED lighting drivers through standard network components such as gateways (including other components such as servers and border routers (BR), etc.) and nodes (for example, powerline outdoor lighting controller (PL OLCs), radio frequency (RF) OLCs, sensors, etc.) may be installed (provisioned) in any of these network devices. Of course, once a node is added (provisioned) to a gateway, the gateway and node communicate with each other such that the gateway may be used to provide commands to the node such as configurations including lighting configurations. The lighting configurations provide an ability to finely control LED light output, such as brightness and light frequency mixtures can contribute to safety as light can be “tuned” utilizing lighting configurations to do a number of things such as cutting through fog (outdoors), as well as providing vitamin D light therapy, or setting a mood or improving aesthetics all while avoiding circadian disruption (both outdoors and indoors).

Note that throughout this document when the term “property” is used, it is assumed that this means, for the gateway, a value or set of values gettable/settable via a web page or via simple object access protocol (SOAP). For the node, it means a value or set of values gettable/settable via network management messages. In any case, properties are persistent.

### Exemplary Architectures and Devices

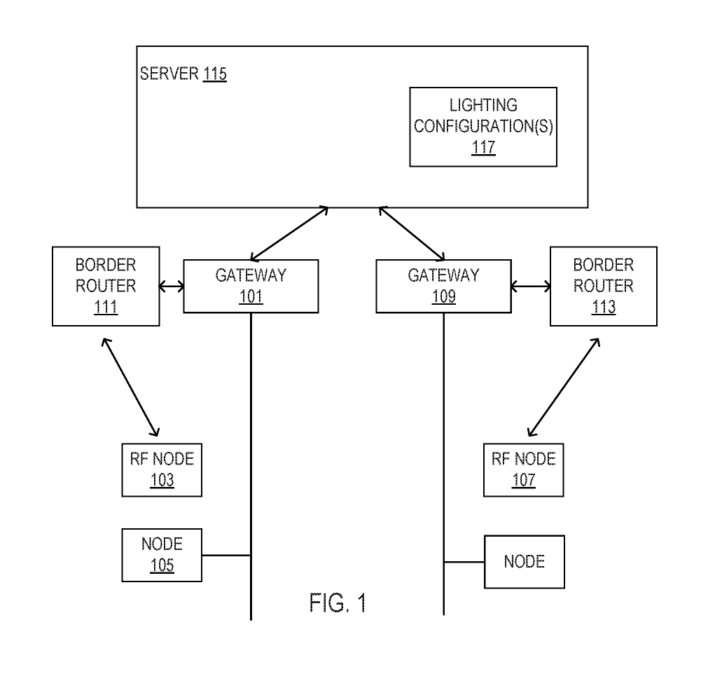

FIG. 1 shows lighting configuration storage in a managed server that acts as a repository for gateways and nodes to obtain configuration information.

In communication with the server 115, and coupled thereto, are one or more gateways 101, 109 which interface with border routers 111, 113. The gateways 101, 109 are capable of interfacing with networks that use different protocols. For example, receiving and transmitting powerline communications from PL nodes such as node 105 or wireless communications from nodes 103, 107 and also communicating with server 115. The gateways 101, 109 may also manage and control a plurality of nodes as shown.

Border routers 111, 113 couple to gateways 101, 109 respectively and provide an interface to wireless networks (if the gateways 101, 109 do not already do so). In some embodiments, the border routers are a part of the gateways.

The architecture of a gateway 101, 109 with a border router 111, 113 and nodes 103, 105, 107 allows for scalable control and monitoring of the networked nodes, for example 103, 105, 107. In some embodiments, the gateways 101, 109 have features such as a built-in astronomical clock and scheduler, which can be used to switch their networks of nodes on and off and adjust lighting configurations based on fixed or sunrise/sunset timings for that particular location. Additionally, the gateways 101, 109 talk to an energy meter to collecting data for an entire segment handled by the gateway 101, 109 to be used for billing and analytics. Gateways 101, 109 communicate remotely with the server 115 via TCP/IP, 3G modem, LTE, GPRS connections, etc.

In some embodiments, for the server 115 to track what is going on in the network, events are sent from the gateways 101, 109 to the server 115 on certain changes. For example, the gateways 101, 109 alert the server 115 when: a node is added, a node is removed, and/or when a node is rejected. In some embodiments, the node add notification includes the added node's ID, the number of hops, and the worst case link quality indication (LQI) of any hop. In some embodiments, the node remove notification is sent when a node is automatically removed by the gateway 101, 109. In some embodiments, a node rejection notification is sent when a node associates with a gateway, but is rejected either due to a blacklist or a maximum route cost (MRC) violation.

The server 115 also stores lighting configurations 117 in memory. A lighting configuration is a series of labeled commands that a hardware processor loops through to generates a lighting effect (a particular color, or a color flashing, dimming, etc. . . . or any combination of effects). Each command in the series specifies a variable length digital sequence resulting in an electrical current or voltage to be sent to a red, green, or blue LED causing the output of light of one or more of these color wavelengths. For example, using Pulse Width Modulation (PWM) a LED driver sends pulses of a specific amplitude and duration, which are modulated by the commands, to a particular LED. As such, PWM may be used for visible lighting effect and/or for data. For example, the blue content of the light can be gradually increased at daybreak and then reduced over the day or totally eliminated at certain time of the day to curtail any circadian disruption caused by the lighting. In some embodiments, this is a default configuration for consumer lighting (programmable or non-programmable lighting). Details about configurations 117 and their use are described later.

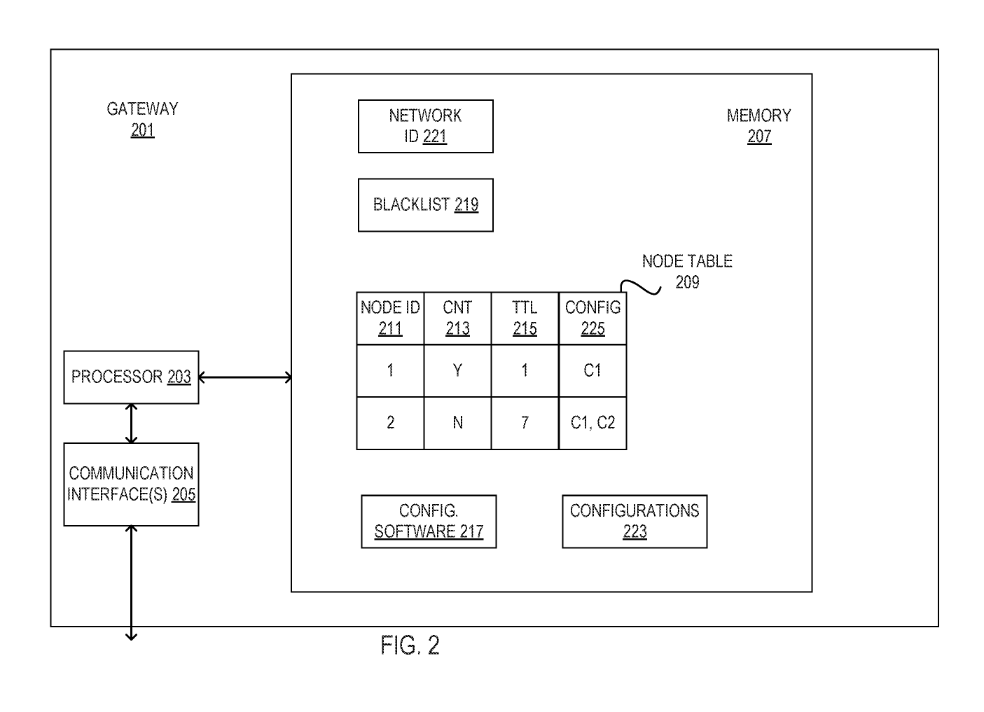

FIG. 2 illustrates an exemplary embodiment of a gateway. The gateway includes a hardware processor 203, such as a microcontroller or central processing unit, to execute instructions stored in memory 207. The gateway 201 also includes lighting configuration software 217 which manages lighting configurations (e.g., pushed from server 115) stored in the node table 209 as node related configurations found in 223. In some embodiments, the gateway 201 includes a lighting configuration table.

Memory 207 may be one or more types of read-only memory (ROM) and/or writeable memory such as random access memory (RAM) or non-volatile storage such as FLASH or disk. The memory 207 includes one or more of: a node table 209 that include lighting configuration information for each node 225, a network identification 221 of the gateway 201, a blacklist 219 of nodes that are not allowed to communicate with the gateway 201, and one or more software algorithms/methods 217 to perform embodiments of one or more of the methods detailed herein. Note in the illustrated embodiment, the lighting configuration information for each node 225 is a part of the node table 209, however, separate structures may be utilized. In some embodiments, the lighting node table is a list of MAC IDs and configurations assigned or in use by nodes communicating with the gateway. The server provides the configuration list in most scenarios. In an embodiment, the node table 209 includes fields for node IDs 211, a counter indication of if the node has multiple configurations 213, and a pointer to individual configurations at each node 225 and a time to live (TTL) value 215 (also called a hold time). The configurations 223 may be stored in the memory of the gateway or in one or more other devices. Typically, the TTL is used for any node that was automatically added, and when the node is out of communication for longer than the time value, the node is automatically removed. The TTL 215 may be updated to reflect the passage of time or be a “static value” and a separate counter is kept to track the passage of time.

The gateway 201 includes at least one communication interface 205. For example, the gateway 201 may include one or more of: a wireless interface, one or more identification buttons, a powerline communication interface, etc. For example, the communication interface(s) 205 may include ISO 14908-1, IEEE 802.15.4, 6LoWPan, etc. In other embodiments, some of these interfaces (e.g., wireless ones) are provided by a border router.

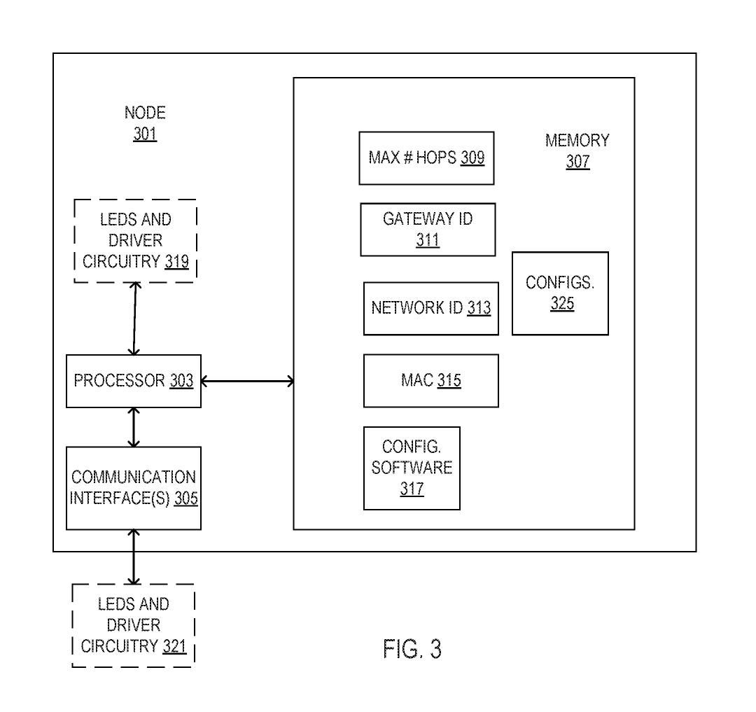

FIG. 3 illustrates an exemplary embodiment of a node. The description herein may apply to a PL node or a RF node or other types of nodes. The node 301 includes a hardware processor 303, such as a microcontroller or central processing unit, to execute instructions stored in memory 307. The node includes lighting configurations 325.

Memory 307 may be one or more types of read-only memory (ROM) and/or writeable memory such as random access memory (RAM) or non-volatile storage such as FLASH or disk. The memory 307 includes one or more of: a maximum number of allowed hops 309, a gateway ID 311, a network ID 313 of the node, media access control (MAC) information 315, and one or more configuration management software/methods 317 to perform embodiments of one or more of the methods detailed herein. The node 301 includes at least one communication interface 305. For example, the node 301 may include one or more of: a wireless interface, one or more identification buttons, a powerline communication interface, etc. For example, the communication interface(s) 305 may include ISO 14908-1, IEEE 802.15.4, 6LoWPan, etc. In other embodiments, some of these interfaces (e.g., wireless ones) are provided by a border router. For example, in some embodiments, an RF node (such as an RF OLC) uses one or more of ISO 14908-1, IEEE 802.15.4, and/or 6LoWPAN compliant wireless communications. For example, in some embodiments, a PL node (such as a PC OLC) uses ISO 14908-1 and -3 powerline based two way communication interfaces. Through the communication interface 305 the memory is programmable to store one or more lighting configurations.

Depending upon the embodiment, LEDs and driver circuitry is internal to the node 301 as shown as LEDs and driver circuitry 319, or external to the node 301 and accessible through a communication interface 305 as shown as LEDs and driver circuitry 321. The LEDs and driver circuitry use stored lighting configurations.

Configuration management leverages discovery mechanisms that are typically available with nodes. In general, when a gateway discovers a node it adds the node to itself and may request one or more lighting configurations from the gateway or directly from a lighting server depending on installation options chosen.

### Node Addition at a Gateway

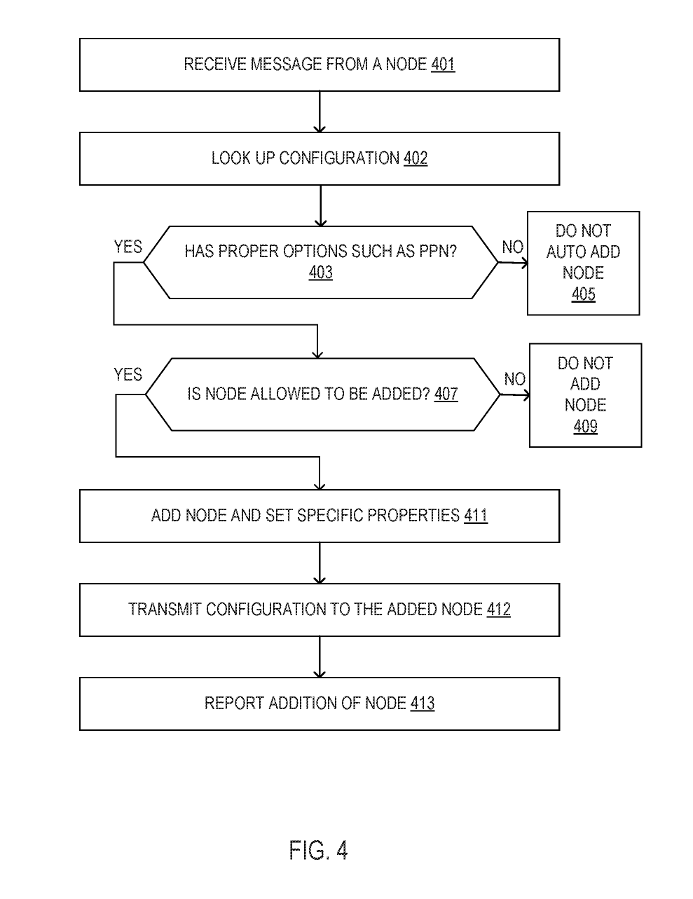

FIG. 4 illustrates an embodiment of lighting node addition to a gateway. At 401, a message is received by the gateway. Through this message a gateway discovers a node via the node's announcement of itself to the gateway. For example, nodes may send a unicast message to a gateway announcing their presence. In some embodiments, this unicast message is an identification message. Typically, RF nodes send a unicast addressed to a border router coupled to the gateway using a border router's known fixed address and the border router then relays this to the gateway, however, more direct communication is contemplated. PL nodes may interact either directly with the gateway or through an intermediary. The unicast message is normally sent on a periodic basis when the node is unconfigured. Once configured, the nodes stop sending this message. Further, the rate of identification messages may change such that a delay between sending these messages increases after each transmission. Once a message is received the gateway can look up any configurations 402 assigned to the node.

In some embodiments, at 403, a determination of options, such as if Plug and Play (PPN) is enabled, is made by the gateway. If the proper options are not enabled, then by default the node is not added automatically at 405 in some embodiments.

If the proper options are enabled, a determination of is the node allowed to be added is made at 407. For example, is the node subject to a blacklist or does it suffer from a MRC (route limiting) violation? As noted above, a blacklist is typically provided by the server that the gateway is coupled to and a check against that list for the node's ID is made. If the ID is found, then the node is not added at 409. If either the MRC hop limit is exceeded or another defect is found, then the node is rejected and not added at 409.

If allowed, the node is added to the gateway at 411 and specific properties are set in the gateway such as the node ID, auto-populated indication (if used), counter indication, pointer to which configuration and TTL indication. Once a node is added then download lighting configurations 412 are transmitted to the node.

In some embodiments, the addition of the node is reported to the gateway's server at 413.

In PL and RF PPN systems, a node could end up reaching more than one gateway and one potential issue is deciding which gateway will automatically add the node and supply the lighting configurations that are consistent with intended use, such as setting the lighting quality in a particular zone controlled by a gateway. Without having a “lockdown” mechanism to tie a node to a gateway, nodes could readily move between gateways, especially in an RF environment. For example, in FIG. 1, node 103 may be close enough to border routers 111 and 113 to potentially reach both of them and could bounce between them. In some embodiments, lockdown is accomplished by using a variety of network IDs wherein each gateway uses a specific network ID with up to “N” network IDs used in a particular installation. The gateway and each node have a property which is the maximum number of network IDs that are possible called the network ID maximum (NIM). When unconfigured and searching for a gateway to obtain lighting configurations and other parameters (e.g., on power up or after a disassociation), an RF node cycles through all the possible NIDs from 0 to NIM-1. In some embodiments, a node's network ID is formed by setting the last byte of the IEEE 802.15.4 network ID to a number in this range and this identification is called the PPN Network ID (PNI). In some embodiments, a network ID is a 16-byte number used by an application's 802.15.4 stack to constrain end nodes in terms of which border router that it can associate with. The end node and BR each have a network ID and the end node won't associate unless the BR has a matching ID. Once an end node associates, it is then given an address in the PAN (consisting of the PAN ID and a 16-bit node number). After that, the network ID doesn't come into play (thus the need for a PAN ID uniqueness even in disparate networks). Without network IDs, there is no way to keep a zone of nodes from mixing lighting configurations from system A, vendor X by associating with a border router from system B, vendor Y.

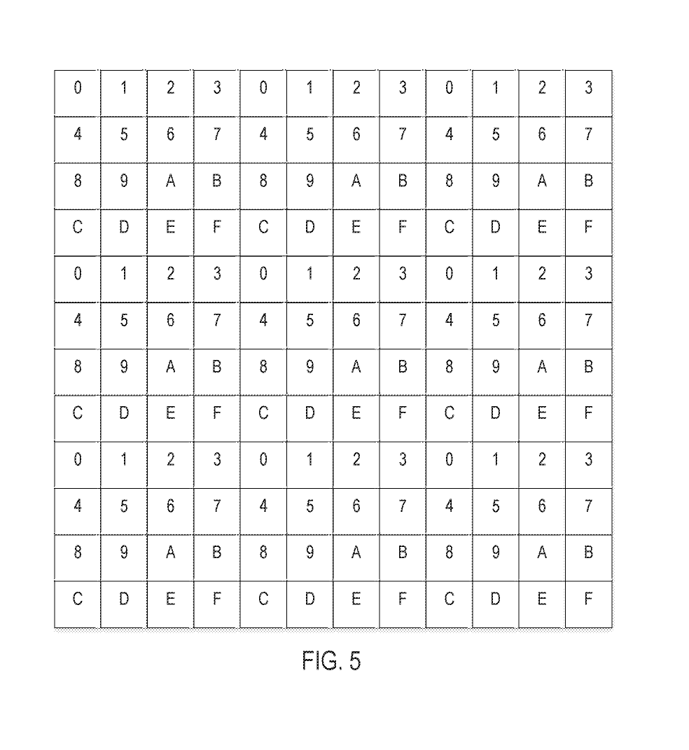

When choosing an NIM value it is usually important to consider how likely a node will associate with the wrong border router and gateway and obtain the wrong lighting configurations. FIG. 5 illustrates an exemplary PNI based layout for choosing a NIM value. Assume the system consists of 144 border routers and 43,200 nodes and that each square represents a bridge router and its associated 300 nodes where the number in the middle is the PNI. A node that is associated with a border router using PNI 0 is unlikely to find its way to another border router with PNI 0. Even if it is possible for a node to find its way to the wrong border router, route limiting (detailed above) can be used to reduce the chances of this. If that still isn't good enough, blacklisting can be used to guarantee that the node doesn't get automatically added to the wrong border router.

### Node Association

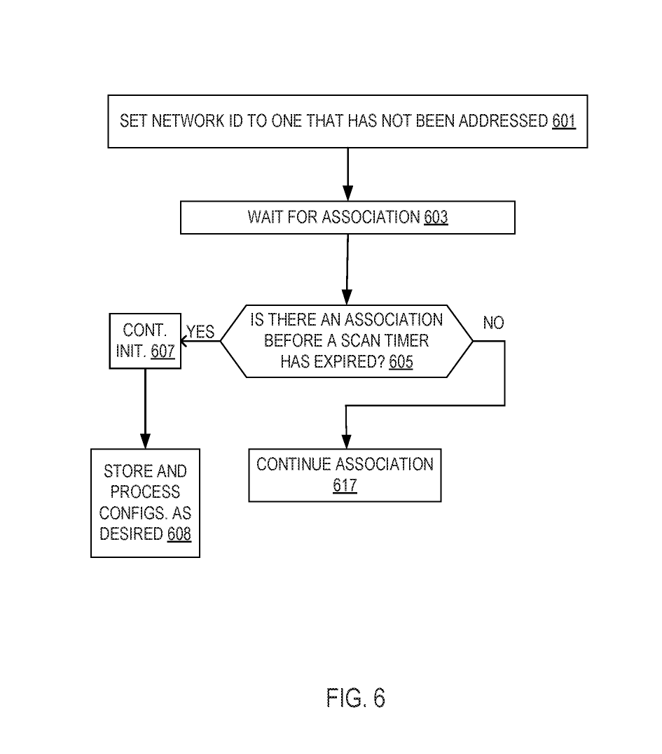

FIG. 6 illustrates an embodiment of a method for a node to associate with a gateway. In some embodiments, at 601, an application sets a network ID (NID) to a particular value (e.g., using a PNI). For example, the NID is one that has not been previously addressed.

At 603, the node waits for an association. A determination of if a scan timer has expired before association is made at 605. A scan timer is a node property that defines the maximum amount of time a node is to wait to get associated with a gateway before giving up and moving on to the next PNI. While not shown in FIG. 3, this is typically stored in memory of the node.

When there is an association before an expiration of the scan timer, any remaining initialization tasks may take place (as needed) and/or normal communications may begin at 607. At 608, lighting configurations are stored and processing of each lighting configuration to a particular system or node function are performed. For example, lighting configurations can be used to control consistent lighting quality in one or more zones controlled by a gateway and include processing such as activating a particular configuration at specific time of day or day of the year or weekends or holidays are performed. Different configurations may be activated when triggered by sensor data for an event such as fire or smoke detection. A different configuration may be activated due to occupancy detected.

When there is not an association before an expiration of the scan timer, then 617 continues the association search process.

### Lost Connection

Nodes can lose their connection to gateways. When a node detects that it has lost its connection to a gateway, it can load a default configuration from the factory

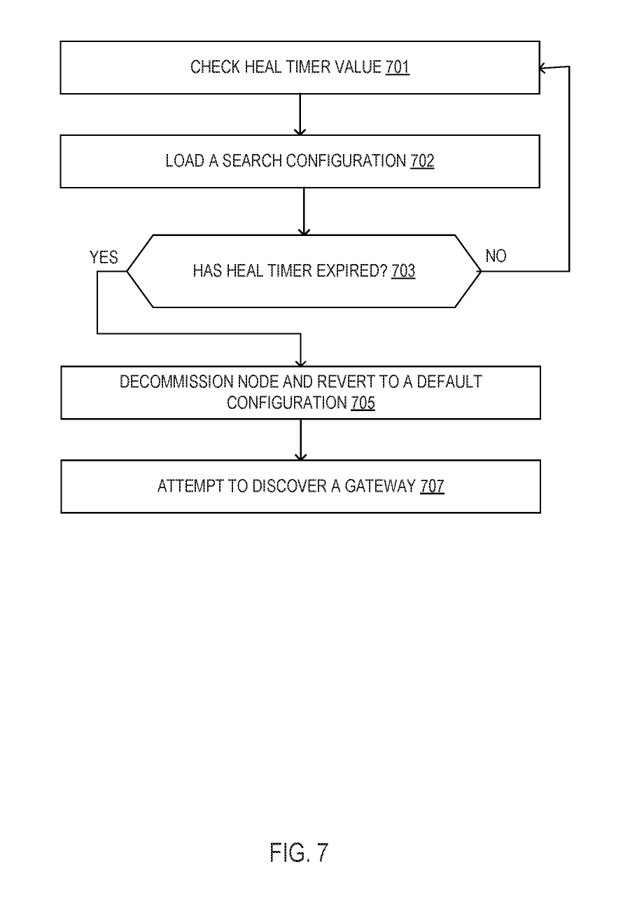

FIG. 7 illustrates an embodiment of a method for handling a lost connection using a heal timer value. A heal timer tracks how long a node waits to associate itself with a gateway. At 701, the node reads its heal timer to get its value. A determination of if the heal timer has expired is made at 703, if it has not then a search configuration is loaded at 702 and the heal timer is checked again at a later point in time.

When the heal timer has expired, the node decommissions itself at 705 and utilizes a default lighting configuration at this time, but continues to attempt to discover a different gateway at 707. For example, the method of FIG. 6 is performed.

On the gateway side, the hold timer (TTL) will eventually expire causing the gateway to remove the node from its list of added nodes.

### Node Reassignment

In some instances, it may be beneficial to reassign a node from one gateway to another. When a node is removed from a gateway, it is de-commissioned. The act of de-commissioning puts the node in a state where it can be discovered by another gateway. The de-commission from the gateway will issue a command to start this process. At this point the node could be directed to use its default lighting configuration or supplied with a different configuration from the gateway such as a specific lighting color to visually indicate the node is not associated with a gateway.

If an RF node becomes associated with a gateway's border router and the gateway rejects the node for some reason (e.g., blacklisting, route limiting), then the gateway issues a disassociate command and a lighting configuration directing the use of a specific color, visually indicating a particular problem could be specified to be used. This is useful in problem determination and can shorten diagnosis times.

In some embodiments, the server examines the route cost for each node, GPS coordinates of the nodes and gateways and given that information, determine which nodes are not optimally associated. The server then forces a reassignment for those nodes by updating the blacklist and removing the nodes. In this case, a specific lighting configuration directing the use of a specific color and a series of flashes at a timed interval are used to flash out a code for this specific situation.

### Handheld Device Provisioning

In some embodiments, a hand held device (e.g., smart phone) is used to provision the end node (e.g., with GPS coordinates) prior to pairing with a gateway. In this case lighting configuration(s) may be supplied by the hand held which reduces problem determination time and skill level because different “visually” noticeably lighting configurations can be employed to indicate node state (disassociated, searching, etc.). In addition, the hand held may request error codes to be flashed out by the LED driver as light. For example, flashing a red LED only detectable by a hand held representing an error code where the hand held is looking for a particular wavelength or flash pattern a human cannot see. The hand held can make the flashing activity human visible by the light fixture by using slower flash frequency and/or longer duration, etc. and available by command.

In some embodiments, error codes are represented through the lighting configurations or activated (or accessed) through hand-held devices.

### Lighting Control Using Configurations

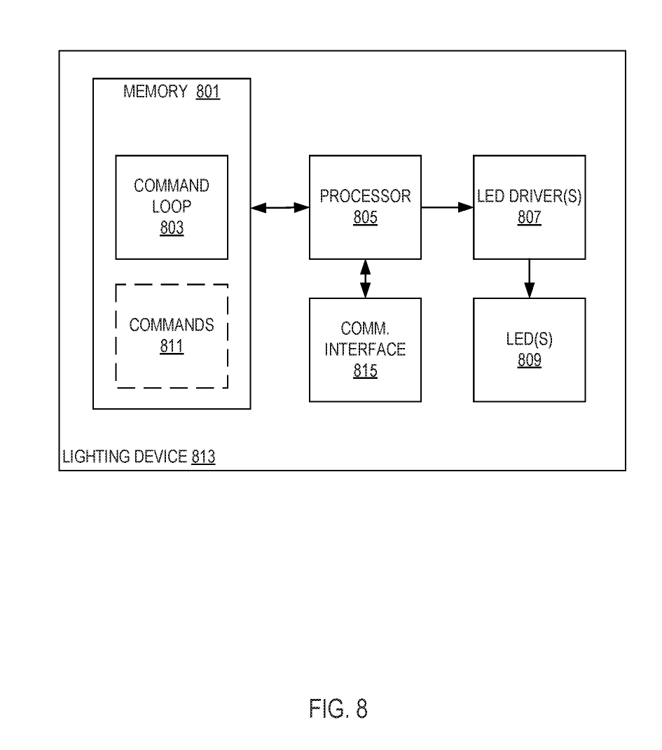

In some embodiments, lighting control is accomplished by using a programmable loop of lighting commands (e.g., a lighting configuration) that optionally continuously repeat until reset or interrupted. Any combination of single or multiple commands can be labeled as a configuration. Each configuration could be loaded and executed as a command loop. FIG. 8 illustrates an embodiment of a lighting device that uses command loops to drive one or more LEDs. The lighting device 813 includes memory 801 to store at least one configuration or command loop 803 to be executed by processor 805 (such as a microcontroller or central processing unit (CPU)). The processor 805, for each command it executes, provides an instruction for at least one LED driver 807. This instruction is used by the LED driver(s) 807 to drive one or more LED(s) 809 as directed. In some embodiments, the memory 801 also includes stored commands 811 that are selectable for use in at least one command loop 803. In one embodiment, the command loop 803 is a string of pointers to commands 811. A communication interface 815 is used to communicate with external devices such as a server or a handheld device. Commands and instructions may be received via this interface 815 to start, stop, or alter a command loop 803 or load or delete new commands 811. In some embodiments, the command loop 803 and processor 805 is located inside the LED driver 807.

In some embodiments, default configurations are set for consumer lighting (programmable or non-programmable lighting).

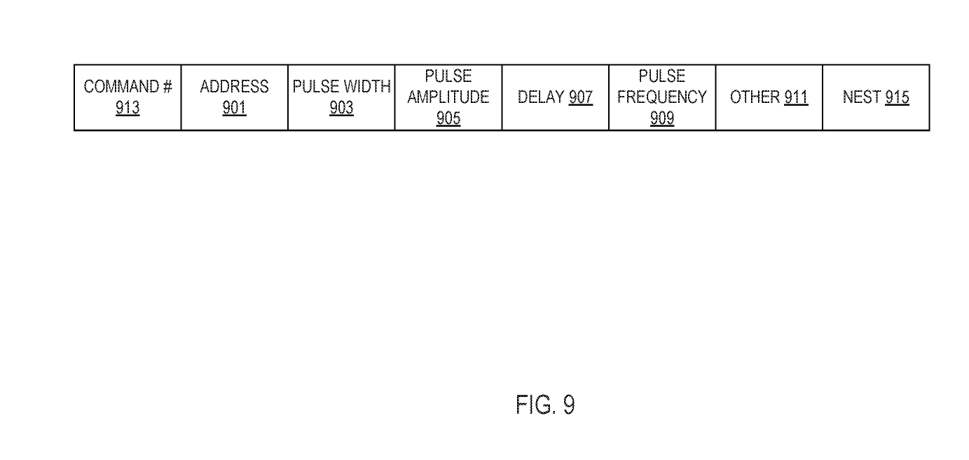

A command in the loop causes the generation of a voltage or current pulse to one or more LEDs. The command specifies the electrical characteristics of each and every pulse generated and sent to each and every LED. An exemplary embodiment of a single command is illustrated in FIG. 9. Being illustrated does not mean that a field is included in all embodiments of a command.

A command includes a command number (or name) field 913. This field 913 allows for one command to be differentiated from another. A command name could also be referenced as a configuration name.

Addressing field 901 specifies a LED driver or drivers (and associated LEDs) or controller to send a current or voltage pulse or pulses to LEDs. Other electrical characteristics could be specified in the command such as phase shift or rate of current or voltage increase or decrease. For example, this command is addressed to a particular LED, addressing could be a single address to a specific LED or addressed to a group(s) of LED or all LEDs which could be considered analogous to a broadcast address.

A pulse width field 903 provides the length of a pulse of energy sent to the LED. For a pulse width modulation (PWM) command, the pulse may be long (could be infinite with continuous LED driver output to a one of more LEDs until reset or interrupted). Other commands use one or more shorter pulses. In some embodiments, there is a minimum or maximum value that may be used. Some commands may specify a string of pulses of any size and duration to achieve a desired lighting effect or embed data in the LED light output. In some embodiments, commands are organized to allow nested commands resulting in nested pulses of light or data transmission. This allows separate information streams to do multiple things such as allowing data to ride over the lighting. For example, one or more pulses on top of a wider pulse can be specified where the higher layer of pulses are encoded data or information for driving another lighting frequency. The nesting can continue where a pulse on top of a pulse, on top of a pulse, etc. can be specified to provide information channels for visible light, non-visible lighting effects or data. In some embodiments, a nesting indicator field 915 indicates that a nesting command exists and its depth. Depending upon the implementation, there may be a nesting indicator field 915 per field, or one nesting indicator field 915 to be used by all fields.

A pulse amplitude field 905 provides the amplitude of the pulse of the LED. In some embodiments, there is a minimum or maximum value that may be used.

A delay field 907 specifies a spacing between pulses. In some embodiments, the spacing is between pulses of the same command. In other embodiments, the spacing is between commands.

Optionally in some embodiments, a pulse frequency field 909 provides frequency between pulses or strings of pulses as the number of repetitions required.

An other field 911 may be used for additional instructions such as a phase, an amount of time to execute the command (e.g., 5 seconds), etc.

In a command loop, a single command can be repeated over and over again, or commands may be executed sequentially. For example, all pulses can be individually specified as to duration, amplitude and spacing between them. This combination of repeating pulses within commands (along with repeating commands themselves) creates a lighting effect (color, brightness, embedding of data, etc.). Each combination of single or multiple commands is labeled as configuration or command loop.

There are two main classes of lighting effects this creates. The first class is visible light which generates light that a human eye can see. This light should be consistent enough to provide pleasing, useful, flicker-free lighting. The second class is non-visible lighting effects which happen within the human perceived and useful area lighting range but not causing visible human noticed artifacts such as dimming or flicker, etc. These effects may be used to carry data pulses, cause the LED to emit a bit more or less blue light, generate non-visible lighting that encourages the production of vitamin D in humans, etc. This non-visible impact is programmed into (by, for example, adjusting pulse amplitude for data) and between the lighting pulses. The selection of a configuration activates a mixture of LEDs, modulates the duration, frequency, phase and intensity of light output, etc. to achieve visible and non-visible lighting effects.

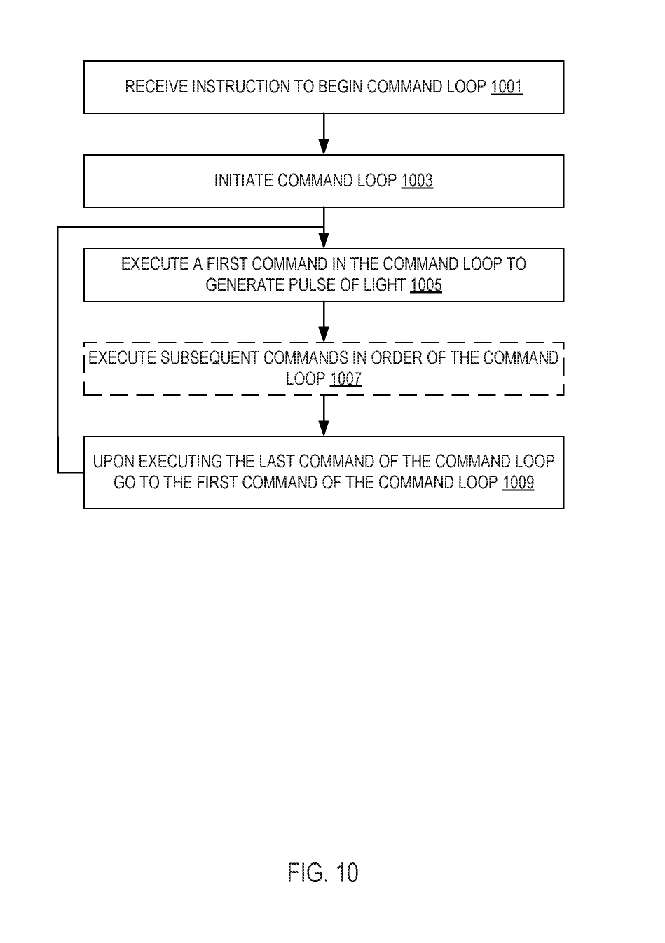

FIG. 10 illustrates an embodiment of a method performed by a lighting device using a command loop. At 1001, an instruction to begin a command loop is received by the lighting device.

At 1003, the command loop is initiated. For example, a processor begins to execute commands stored in memory.

At 1005, a first command of the command loop is executed to generate one or more pulses of light. For example, a processor executes the command to drive one or more LED drivers addressed by the command.

At 1007, in some embodiments, the subsequent commands of the command loop are executed in order. This does not happen in all embodiments as a loop may only have one command.

At 1009, upon executing the last command of the command loop, the loop is restarted by executing the first command of the command loop, followed by subsequent commands, etc.

Commands and configurations may be modified during runtime of a command loop. This changing of the configurations or modification of the configurations is called tuning since the pulse width and duration are dynamically modified on-the-fly by adding/replacing/deleting commands in the loop. Tuning could also involve loop speed being adjusted between a small number and many millions of commands per unit of time (e.g., per second) to achieve a desired lighting (and any embedded data transmission) effects. The lighting caused by looping through the commands could be considered a base lighting effect that achieves a certain color or a combined lighting effect such as generating the color yellow (as a mix of wavelengths interpreted by the human eye as yellow, for example) and/or flashing and or dimming and/or changing colors, etc. Consider each repeating loop as a harmonic frequency of digital lighting commands (such as employing PWM) will achieve a certain color and intensity. The configuration changing and tuning capability described is universal in that it can be employed by other LED control techniques besides Pulse Width Modulation (PWM) by dynamically modifying their behavior such as: On-off keying (OOK), Pulse position modulation (PPM), Pulse amplitude modulation (PAM), Color shift keying (CSK), Variable Pulse Position Modulation (VPPM), etc.

An exemplary use case for PWM for visible lighting effects and not just data is adjusting the blue content of light gradually (e.g., increased at daybreak and then reduced later in the day or totally eliminated at certain time of the day) to curtail circadian disruption caused by the lighting. Or the circadian cycle can be disrupted intentionally. For example, when using lighting as a morning sleep alarm then the lighting that is turned on to wake a person up can be saturated with blue light that not only wakes a person up, but has a cognitive impact that gets the person alert.

Further, configuration changes can be triggered by external events such as fog detected or occupant detected. When a fog or occupant detected signal is sensed by the LED driver it can modify or change any running configuration. The following detail some embodiments of tuning.

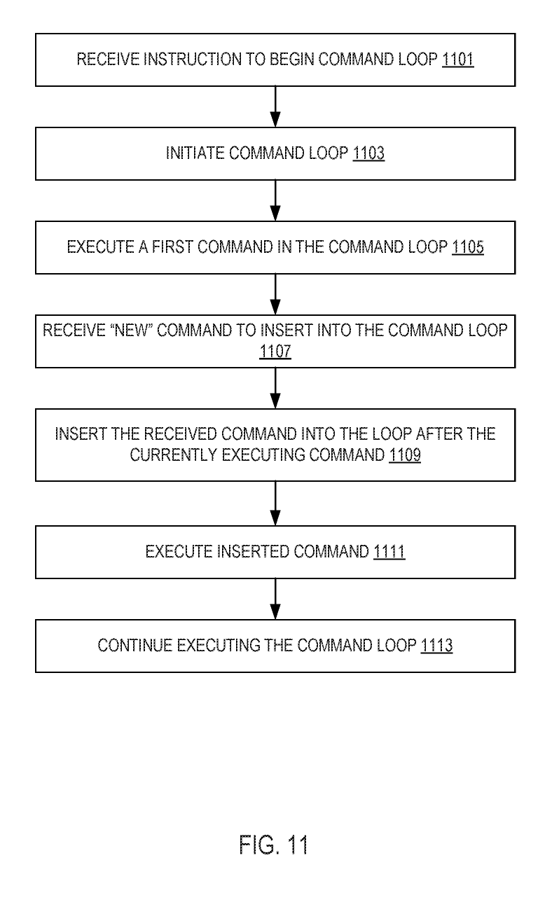

FIG. 11 illustrates an embodiment of a method performed by a lighting device using a command loop. At 1101, an instruction to begin a command loop is received by the lighting device.

At 1103, the command loop is initiated. For example, a processor begins to execute commands stored in memory.

At 1105, a first command of the command loop is executed to generate one or more pulses of light. For example, a processor executes the command to drive one or more LED drivers addressed by the command.

At 1107, a “new” command is received to insert into the command loop. This command may be a command that did not previously exist in the loop (or not in a particular location of the loop), or be an alteration of a command in the loop. This command is typically received over a communication interface and software within the lighting device directs the insertion of the command into the loop.

The received command is inserted into the loop after the currently executing command at 1109.

At 1111, the inserted command is executed.

The execution of the command loop continues at 1113 as if the inserted command was always a part of the loop.

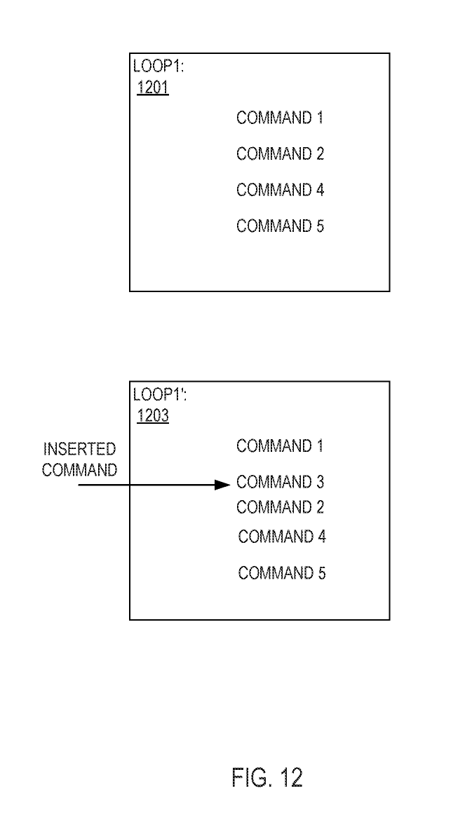

FIG. 12 illustrates an example of a loop and a tuned loop. Loop1 1201 includes for commands (labeled COMMAND 1, COMMAND 2, COMMAND 4, and COMMAND 5). These commands are continually executed to drive at least one LED

Loop1′ 1203 includes for commands (labeled COMMAND 1, COMMAND 3, COMMAND 2, COMMAND 4, and COMMAND 5) wherein COMMAND 3 was inserted during the execution of loop1 1201.

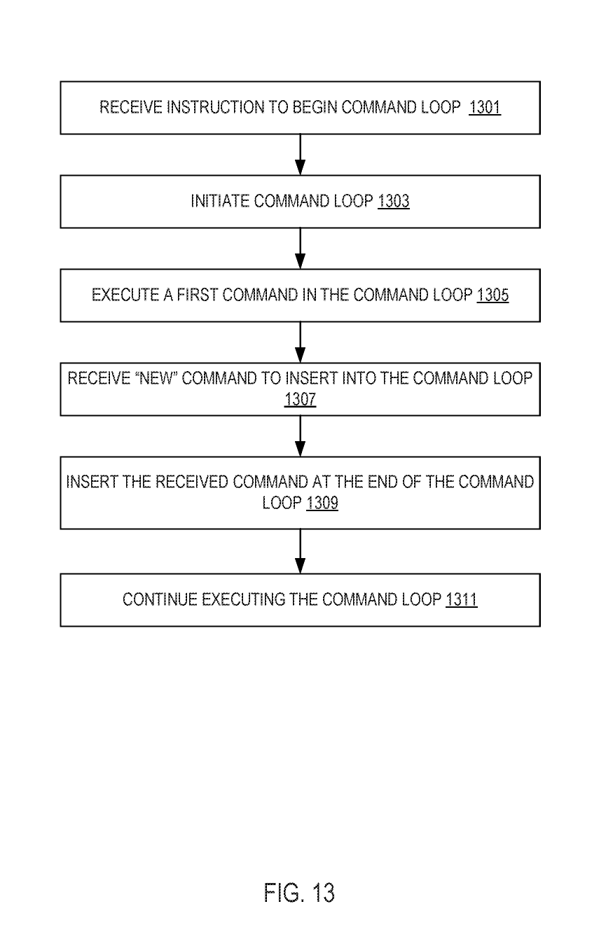

FIG. 13 illustrates an embodiment of a method performed by a lighting device using a command loop. At 1301, an instruction to begin a command loop is received by the lighting device.

At 1303, the command loop is initiated. For example, a processor begins to execute commands stored in memory.

At 1305, a first command of the command loop is executed to generate one or more pulses of light. For example, a processor executes the command to drive one or more LED drivers addressed by the command.

At 1307, a “new” command is received to insert into the command loop. This command may be a command that did not previously exist in the loop (or not in a particular location of the loop), or be an alteration of a command in the loop. This command is typically received over a communication interface and software within the lighting device directs the insertion of the command into the loop.

The received command is inserted into the loop at the end of the command loop at 1309.

At 1311, the execution of the command loop continues as if the inserted command was always at the end of the loop.

In some embodiments, the lighting device does not store a complete command loop. Rather, the loop is streamed to the lighting device for execution. As such, it is possible to only execute commands that are buffered in memory prior to execution. Typically, the lighting device, absent an indication to the contrary (e.g., a new command is received), will repeatedly execute the buffered command until it is told to stop.

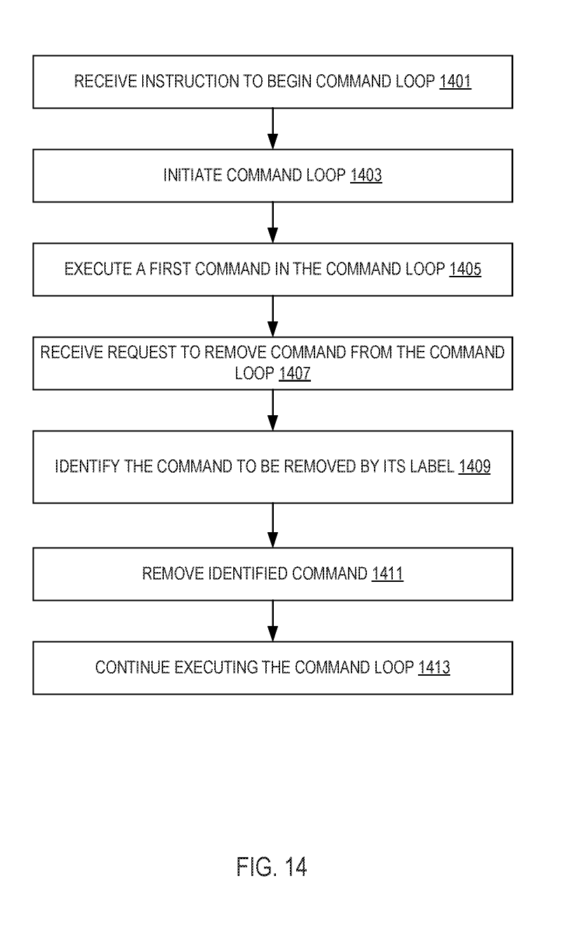

FIG. 14 illustrates an embodiment of a method performed by a lighting device using a command loop. At 1401, an instruction to begin a command loop is received by the lighting device.

At 1403, the command loop is initiated. For example, a processor begins to execute commands stored in memory.

At 1405, a first command of the command loop is executed to generate one or more pulses of light. For example, a processor executes the command to drive one or more LED drivers addressed by the command.

At 1407, a request to remove a command from the command loop is received. This request is typically received over a communication interface and software within the lighting device directs the deletion of the command from the loop.

The command to be removed is identified by its label at 1409. For example, the command name

At 1411, the identified command is removed.

The execution of the command loop continues at 1413 as if the removed command was always not a part of the loop.

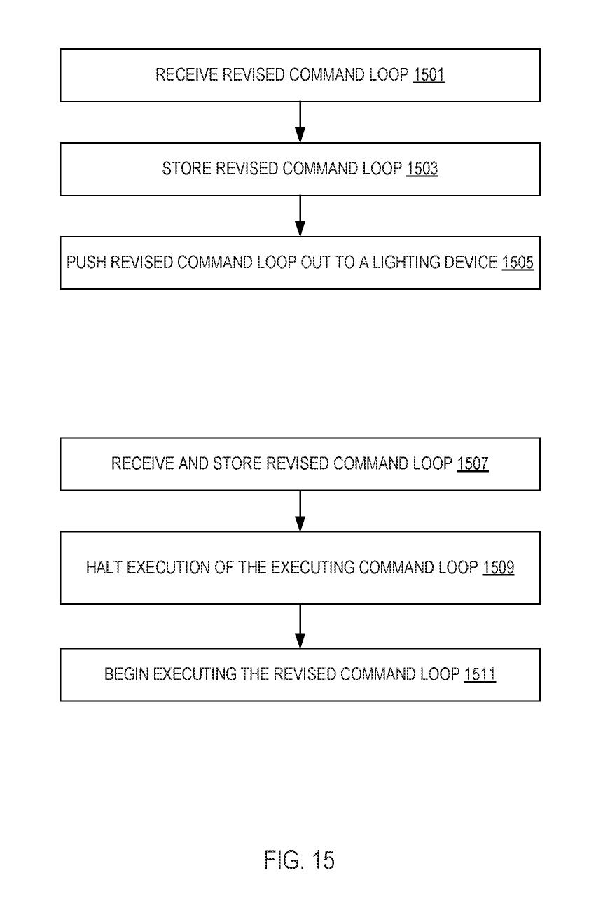

FIG. 15 illustrates an embodiment of a method of updating a command loop. In some embodiments, a server is used to store command loops to be pushed to lighting devices. In those embodiments, at 1501, a revised command loop is received by the server. The revised command loop is stored at the server at 1503 and pushed to a lighting device at 1505. Note that a “revised” command loop may mean an entirely new command loop is stored, or that a command loop that is stored is adjusted.

At 1507, a lighting device receives and stores a revised command loop. This loop may be an entirely different loop sharing nothing with the currently executing loop of the lighting device or it may be an alteration of what is executing.

The command loop that is executing on the lighting device is halted at 1509. In some embodiments, a default command is executed to indicate the lighting device is being updated. In other embodiments, the last executing command is executed while the revised command loop is being initiated.

At 1511, the received, revised command loop is executed by the lighting device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

We claim:

1. An apparatus comprising:
a processor to execute instructions stored in memory;
a communication interface coupled to the processor to communicate with an external device; and
memory to store instructions which when executed by the processor to provide provisioning capabilities for the apparatus, wherein the memory to further store a node information structure including identifiers for each node coupled to the apparatus and configurations available to those nodes.

2. The apparatus of claim 1, wherein the external device is a server.

3. The apparatus of claim 1, wherein the external device is a powerline node.

4. The apparatus of claim 1, wherein the external device is a radio frequency node.

5. The apparatus of claim 4, wherein the radio frequency node is coupled to a lighting control.

6. The apparatus of claim 1, the apparatus is a gateway.

7. The apparatus of claim 1, wherein the memory to further include a counter indication of if the node has multiple configurations.

8. The apparatus of claim 1, wherein the communication interface is one of an ISO 14908-1, IEEE 802.15.4, or 6LoWPan interface.

9. A method comprising:
receiving a message from a node to provision the node;
looking up configurations assigned to the node;
adding the node to a node information structure including an identifier for the node, a pointer to one or more configurations of the node, and a timer to indicate how long to maintain a connection to the node; and
communicating with the added node the assigned configuration.

10. The method of claim 9, wherein the assigned configuration is a loop of commands to be executed by the node to drive at least one LED.

11. The method of claim 9, further comprising:
determining that the node is allowed to be provisioned.

12. The method of claim 11, wherein the determining comprises determining a route cost for the node does not violate a maximum route cost for a node.

13. The method of claim 12, wherein the route cost for the node comprises a number of hops and a worst case link quality indication value.

14. The method of claim 9, further comprising:
sending periodic messages to added nodes indicating that the communication between the added nodes and gateway is okay.

16. The method of claim 9, further comprising:
disassociating any node that does not communicate with the gateway after a period of time has expired.
